(19) United States
(12) Patent Application Publication
(10) Pub. No.: US 2013/0302111 A1
(43) Pub. Date: Nov. 14, 2013

(54) CONCRETE SCREW STRUCTURE

(71) Applicant: Sheng-Tsai SHIH, Kaohsiung City (TW)

(72) Inventor: Sheng-Tsai SHIH, Kaohsiung City (TW)

(21) Appl. No.: 13/468,308

(22) Filed: May 10, 2012

(51) Int. Cl. F16B 25/02; F16B 25/10

(52) U.S. Cl. 411/387.4

(57) ABSTRACT

A concrete screw includes a screw head and a rod with a drilling tail section at a distal end thereof. The rod includes a first thread section formed annularly thereon and extended upwards from the drilling tail section, and a second thread section encircling between at least two thread pitches of the first thread section and having an outer diameter smaller than that of the first thread section. The rod further includes a third thread section on an upper end thereof encircling between at least two thread pitches of the first thread section. As the outer edge of the second thread section butts the wall of the screw hole, the first thread section can steadily perform cutting without swaying. Moreover, through the third thread section, compact effect is thereby achieved at a position near the screw head. Hence the concrete screw can provide precise, effort-saving and steady fastening effect.

### FIELD OF THE INVENTION

The present invention relates to a screw, and particularly to a concrete screw structure for a concrete or stone construction material.

### BACKGROUND OF THE INVENTION

A conventional concrete screw is generally used for fastening workpieces with various types of materials, e.g., wood, plastic, metal and concrete. A screw rod of a conventional concrete screw is formed by a spiral thread section for allowing the screw to be screwed into the workpiece for fastening.

However, in a process of screwing a screw into a workpiece, as the circular thread of the screw, the screw is in linear or planar contact with the workpiece when cutting the workpiece, namely the screw receives greater frictional resistance from the workpiece and is prone to sway and deviate. Further, since crumbs of the workpiece are likely accumulated when the workpiece is cut by the thread plane of the screw, more effort and time are needed for fastening. In the event that too many crumbs are accumulated without discharging, frictional force during screwing would be increased to result in fracture of the workpiece. Therefore, there is a need for a solution that mitigates or even eliminates the above disadvantages.

### SUMMARY OF THE INVENTION

To mitigate and eliminate the above disadvantages, the present invention provides an improved screw structure capable of reducing cutting resistance as well as increasing a processing speed and optimizing fastening effect.

A concrete screw is provided according to the present invention. The concrete screw comprises a screw head and a circular rod. The circular rod is extended downwards from the screw head and comprises a drilling tail section at a distal end thereof. The rod further comprises a first thread section formed annularly thereon and extended upwards from the drilling tail section, and a second thread section encircling between at least two thread pitches of the first thread section and having an outer diameter smaller than that of the first thread section. The rod further comprises a third thread section on an upper end thereof encircling downwards between at least two thread pitches of the first thread section. The third thread section has an outer diameter between those of the first and second thread sections. The first, second and third thread sections are unsymmetrical threads. Moreover, the first thread section further comprises a serrated cutting edge formed on an outer edge thereof and from the drilling tail section at a selected length. The rod further comprises at least one thread cutting slot at one side of a lower end thereof.

With the structure above, the concrete screw of the present invention offers the following advantages.

First of all, when the concrete screw is screwed into a screw hole, as the second thread section has a relatively small outer diameter, the outer edge of the second thread section butts against an inner wall of the screw hole, such that the first thread section can steadily perform cutting and be screwed into a workpiece precisely, hence fastening precision improves.

The third thread section of the concrete screw of the present invention offers a reinforcing bite force at a position near the screw head, so that the concrete screw provides more steady fastening effect when being screwed into a workpiece and is thus prevented from deviation or loosening.

The first, second and third thread sections of the concrete screw of the present invention are unsymmetrical threads, thus can reduce contact area between the concrete screw and a workpiece to lower a frictional force when the concrete screw is screwed into the workpiece, thereby is achieved time-saving and effort-saving effect.

An outer edge of the first thread section is provided with a serrated cutting edge, thus can increase a speed for damaging fibers of a workpiece when the concrete screw is screwed into the workpiece to optimize processing efficiency.

Further, the rod of the concrete screw of the present invention comprises a thread cutting slot at a lower end thereof. The thread cutting slot can accommodate and quickly discharge crumbs of a workpiece and prevent fracture of the workpiece caused by excessive frictional force generated when the concrete screw is screwed into the workpiece, thereby is achieved securely fastening effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an elevational view of a concrete screw according to one embodiment of the present invention.

FIG. 2 is a front view of FIG. 1

FIG. 3A is a diagram of FIG. 1 from another angle.

FIG. 3B is a partial sectional view along 3B-3B of FIG. 3A.

FIG. 3C is a partial view from a 3C direction in FIG. 3B.

FIG. 3D is an enlarged partial view of an unsymmetrical thread in FIG. 3A.

FIG. 4A is a sectional view of a concrete screw according to one embodiment of the present invention.

FIG. 4B is an enlarged partial view at a position 4B in FIG. 4A.

FIG. 4C is an enlarged partial view at a position 4C in FIG. 4A.

FIG. 5 is a schematic diagram of according to an embodiment of the present invention.

FIG. 6 is a schematic diagram of according to another embodiment of the present invention.

### DETAILED DESCRIPTION OF THE PREFERRED EMBODIMENTS

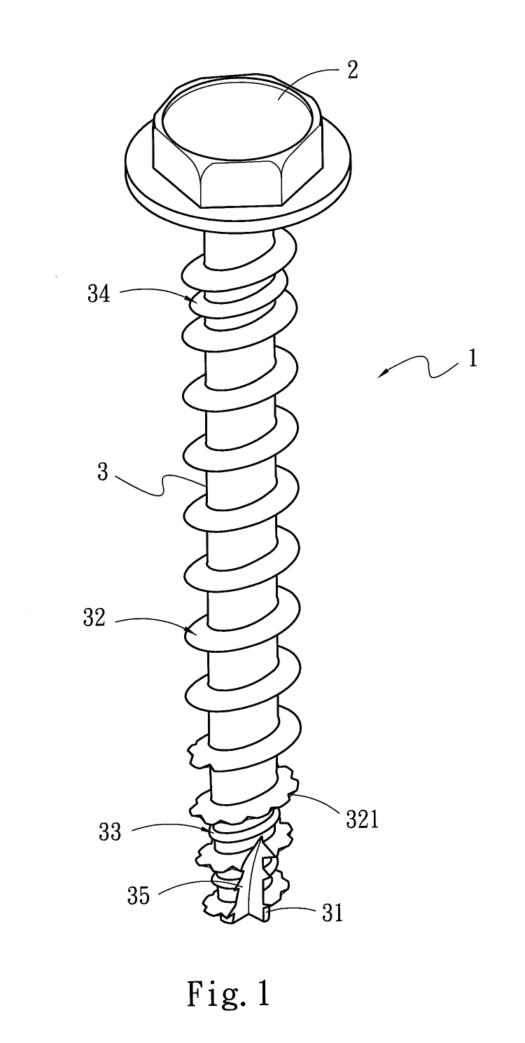

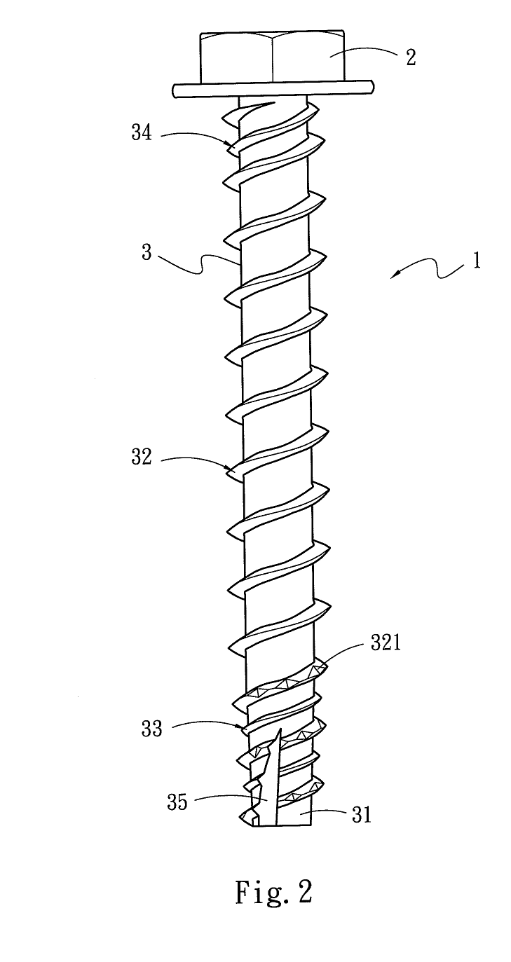

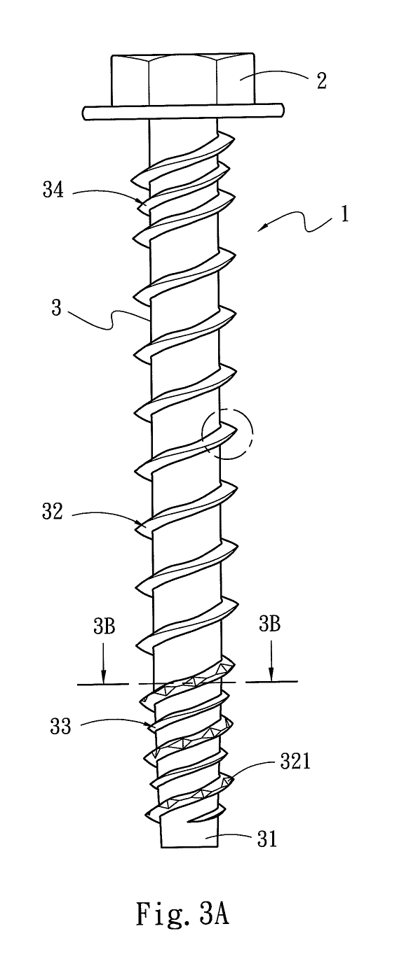

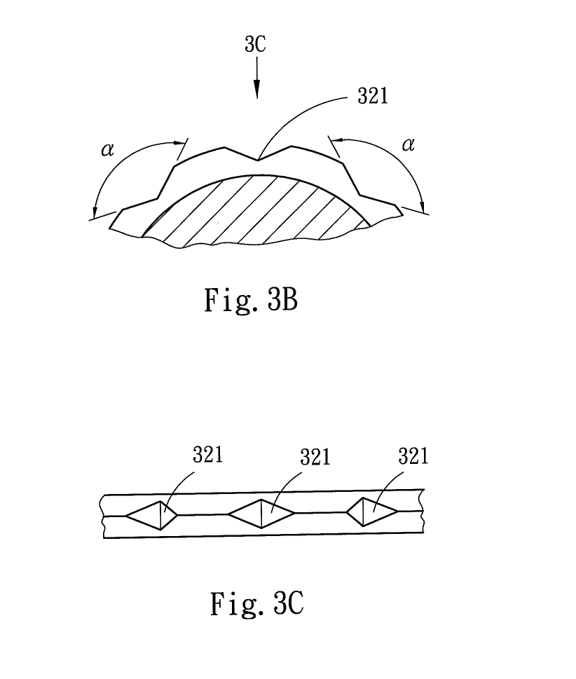

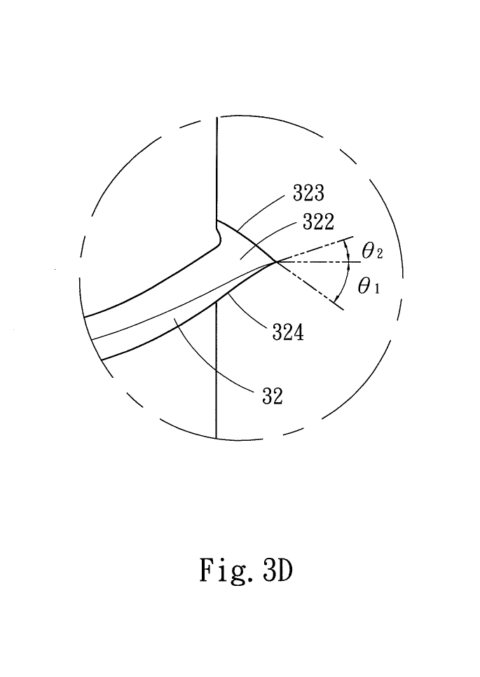

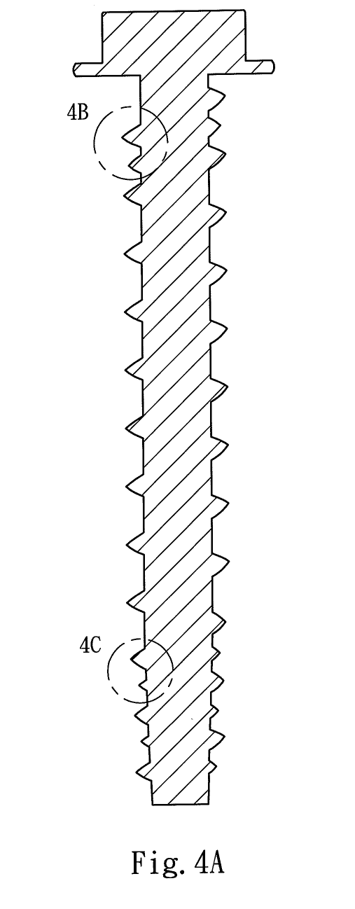

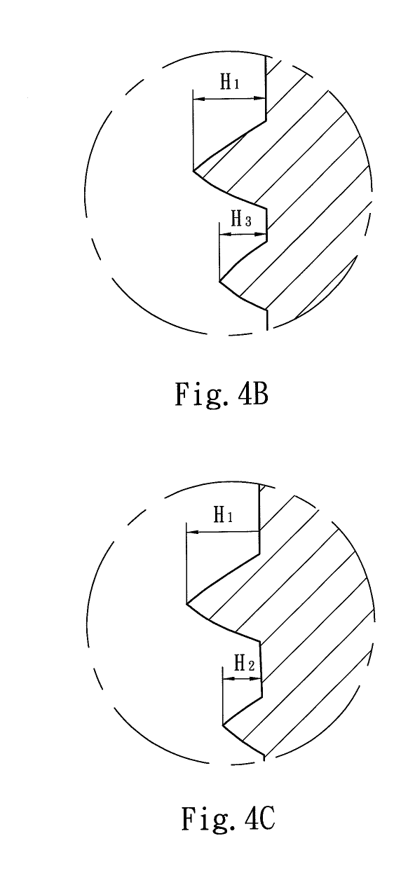

Referring to FIGS. 1, 2 and 3A, a concrete screw 1 according to one embodiment of the present invention comprises a screw head 2 and a rod 3. The rod 3 is a circular rod and is extended downwards from the screw head 2. The rod 3 comprises a drilling tail section 31 at a distal end thereof, a first thread section 32 formed annularly thereon and extended upwards from the drilling tail section 31, and a second thread section 33 encircling between at least two thread pitches of the first thread section 32. An outer diameter of the second thread section 33 is smaller than that of the first thread section 32, and is one-third of that of the first thread section 32. The rod 3 further comprises a third thread section 34 at on upper end thereof. The third thread section 34 encircles downwards between at least two thread pitches of the first thread section 32. An outer diameter of the third thread section 34 is between those of the first thread section 32 and the second thread section 33, and is two-thirds of that of the first thread section 32. Therefore, a thread height H₃ of the third thread section 34 is greater than a thread height H₂ of the second thread section 33 but smaller than a thread height H₁ of the first thread section 32, as shown in FIGS. 4A, 4B and 4C. Further, the first thread section 32 has a serrated cutting edge 321 formed on an outer edge thereof and from the drilling tail section 31 at a selected length. Referring to FIGS. 3B and 3C, an included angle α of the serrated cutting edge 321 is an obtuse angle and is evenly distributed at a lower thread part of the first thread section 32, so as to effectively reduce frictional force when the concrete screw 1 is screwed. The first thread section 32, the second thread section 33 and the third thread section 34 are unsymmetrical threads. Referring to FIG. 3D, the unsymmetrical thread means that a first angle θ₁ which is formed between a first cutting plane 323 of a thread edge 322 of the first thread section 21 and a horizontal plane and a second angle θ₂ which is formed between a second cutting plane 324 and a horizontal plane are not equal. Angles of unsymmetrical threads of the second thread section 33 and the third thread section 34 are the same as those of the first thread section 32. The rod 3 further comprises at least one thread cutting slot 35 at one side of a lower end thereof. The thread cutting slot 35 penetrates a lower end of the drilling tail section 31 to accommodate and discharge crumbs produced from cutting.

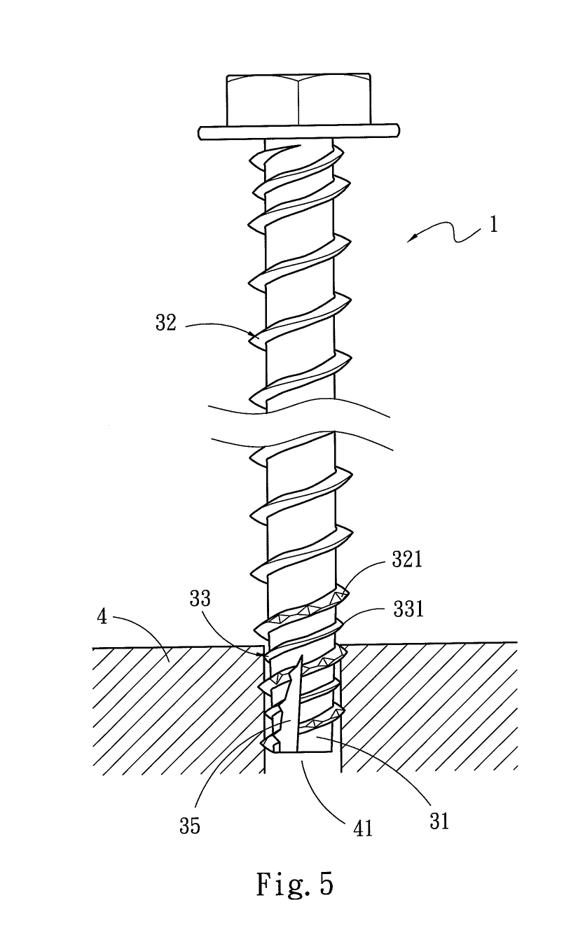

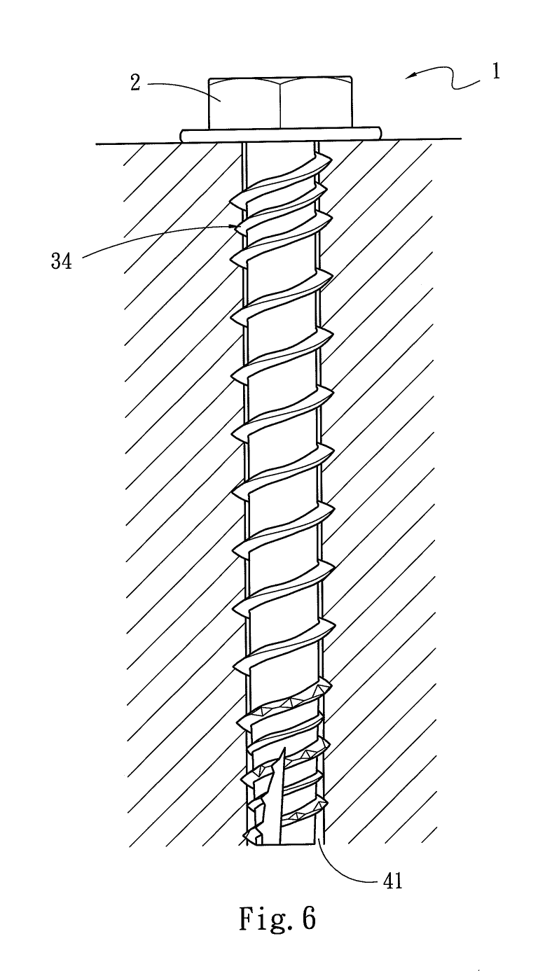

Referring to FIG. 5, when the concrete screw 1 is in use according to the embodiment of the present invention, a concrete workpiece 4 is first drilled to form a screw hole, and the first thread section 32 is guided and screwed into the screw hole 41 via the drilling tail section 31. An outer edge 331 of the second thread section 33 butts against an inner wall of the screw hole 41, so that the first thread section 32 can perform cutting precisely and prevent the concrete screw 1 from deviating out of a range of the screw hole 41. Further, the serrated cutting edge 321 of the first thread section 32 is capable of reinforcing a speed of damaging fibers of the workpiece 4, such that the concrete screw 1 may be screwed with smaller force in coordination with the design of unsymmetrical threads. The crumbs produced when tapping the screw hole 41 can be quickly discharged along the thread cutting slot 35 to prevent the workpiece 4 from fracturing due to the increased frictional force caused by accumulated crumbs. Referring to FIG. 6, after the concrete screw 1 has been screwed into the screw hole 41, the third thread section 34 can tightly butt the screw hole 41, so that the concrete screw 1 may provide a reinforcing bite force at a position near the screw head 2 without loosening after being screwed, thereby is achieved precise, effort-saving and steady fastening effect.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A concrete screw, comprising:
a screw head; and
a circular rod, extended downwards from the screw head, comprising:
a drilling tail section at a distal end thereof;
a first thread section formed annularly thereon and extended upwards from the drilling tail section;
at least one thread cutting slot at one side of a lower end thereof;
a second thread section on the lower end thereof, encircling upwards between at least two thread pitches of the first thread section, wherein the second thread section is formed at an outer diameter smaller than that of the first thread section; and
a third thread section on an upper end thereof, encircling downwards between at least two thread pitches of the first thread section, wherein the third thread section is formed at an outer diameter between those of the first thread section and the second thread section;
wherein the first thread section includes at least one serrated cutting edge formed on an outer edge thereof and from the drilling tail section at a selected length.

2. The concrete screw of claim 1, wherein the first thread section, the second thread section and the third thread section are unsymmetrical threads.

3. The concrete screw of claim 1, wherein the outer diameter of the second thread section is one-third of that of the first thread section.

4. The concrete screw of claim 2, wherein the outer diameter of the second thread section is one-third of that of the first thread section.

5. The concrete screw of claim 1, wherein the outer diameter of the third thread section is two-thirds of that of the first thread section.

6. The concrete screw of claim 2, wherein the outer diameter of the third thread section is two-thirds of that of the first thread section.

7. The concrete screw of claim 3, wherein the outer diameter of the third thread section is two-thirds of that of the first thread section.

8. The concrete screw of claim 4, wherein the outer diameter of the third thread section is two-thirds of that of the first thread section.
